(19) United States
(12) Patent Application Publication
(10) Pub. No.: US 2024/0360887 A1
(43) Pub. Date: Oct. 31, 2024

(54) SHOCK ABSORBING DEVICE

(71) Applicant: Extreme Biomec S.r.l., Barbarano Mossano (IT)

(72) Inventor: Franco Fratton, Barbarano Mossano (IT)

(21) Appl. No.: 18/649,907

(22) Filed: Apr. 29, 2024

Related U.S. Application Data
(60) Provisional application No. 63/462,533, filed on Apr. 28, 2023.

(51) Int. Cl. F16F 15/027; B62K 19/00; F16F 9/02; F16F 15/023

(52) U.S. Cl. CPC F16F 15/0275; F16F 9/02; F16F 15/0232; B62K 19/00; B62K 2201/08

(57) ABSTRACT

A shock absorbing device may include a housing, a piston, and membrane. The housing may define space. The piston may move within the space to adjust a pressure of a gas in a main spring chamber to form a gas spring. The piston and the housing may partially define the main spring chamber within the space. The membrane may be positioned in the space. The housing and the membrane may define a secondary spring chamber within the space. The membrane may partially define the main spring chamber and may be sufficiently elastic such that when the piston adjusts the pressure of the gas in the main spring chamber, a force applied on the membrane by the gas in the main spring chamber changes and causes the membrane to selectively deform to adjust a pressure of gas in the secondary spring chamber to control a spring rate of the gas spring.

### CROSS-REFERENCE TO RELATED APPLICATION

This patent application claims the benefit of and priority to U.S. Provisional App. No. 63/462,533 filed Apr. 28, 2023, titled “Multiple Chamber Air Spring with Elastic Seal,” which is incorporated in the present disclosure by reference in its entirety.

### FIELD

The embodiments discussed in the present disclosure are related to suspension (or “shock absorbing”) devices.

### BACKGROUND

Unless otherwise indicated in the present disclosure, the materials described in the present disclosure are not prior art to the claims in the present application and are not admitted to be prior art by inclusion in this section.

A vehicle may traverse terrain that includes obstacles. The vehicle may include one or more shock absorbing devices configured to suspend the vehicle and absorb impact forces on one or more of the wheels due to the obstacles. In addition, through energy dissipating damping, the shock absorbing devices may be configured to reduce an amount the vehicle shakes or vibrates due to the obstacles. For most applications, reduced friction, weight, and size, and increased tunability of the spring rate and damping rate are desirable characteristics.

Some shock absorbing devices include a gas, often air, spring to suspend the vehicle at a determined height and store and release energy created by the impact forces on the wheels. Spring rates are a function of the amount of energy required to compress a gas to a given pressure. The spring rate of the gas spring is based on an initial pressure of gas in a main chamber of the shock absorbing devices. At any temperature constant, gases (e.g., air), as shown by Boyle's Law, have a progressive compression rate, which causes the spring rate of the gas spring to be inconsistent as the gas is compressed through the travel stroke of the shock absorbing devices (e.g. the spring rate is not linear). Further, the volume of the main chamber may not be readily adjusted, which may prevent the shock absorbing device from providing adjustable control of the spring rate of the gas spring along different portions of the stroke of the shock absorbing devices.

Some shock absorbing devices may include a spacer that is configured to be positioned in the main chamber to reduce the volume of the main chamber. However, a spacer may be difficult to install, requiring disassembly to access the main spring chamber. Additionally, a volume of the spacer is predefined, preventing the spacer from providing adjustable control of the spring rate of the gas spring along different portions of the stroke of the shock absorbing devices without replacing the spacer every time.

Some shock absorbing devices may include an additional reservoir or a floating piston and a dynamic seal that forms a secondary chamber to provide adjustable control of the spring rate of the gas spring along different portions of the stroke of the shock absorbing devices. For example, gas in the secondary chamber may be compressed or decompressed as a function of the pressure of the gas in the main chamber and a function of the pressure of gas in the secondary chamber allowing control of the spring rate of the gas spring. However, the additional reservoir and the floating piston and the dynamic seal may increase a number of seals and seal friction, causing increased hysteresis which undermines controlled damping of the shock absorbing devices movement. The additional friction associated with dynamic seals between gas spring chambers has many undesirable affects: increased wear; increased heat buildup affecting a damper and spring systems; and, decreased sensitivity. The additional seals also require increased maintenance and are an additional failure point when compared to shock absorbing devices that do not include the dynamically sealed additional reservoir or the floating piston.

Therefore, there is a need for a shock absorbing device that provides adjustable control of the spring rate of the gas spring without increasing a number of seals that cause friction, heat, hysteresis, lack of control and which may fail.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One or more embodiments described in the present disclosure may include a shock absorbing device that includes a main spring chamber (e.g., a first chamber) and a secondary spring chamber (e.g., a second chamber or a supplemental chamber) that form the gas spring. The main spring chamber and the secondary spring chamber may provide adjustable control of the spring rate of the gas spring along different portions of the stroke of the shock absorbing device, which may be adjusted based on an initial pressure of the gases in the main spring chamber, the secondary spring chamber, or both.

The shock absorbing device may include an elastic membrane (e.g., an annular clastic membrane or tubular clastic membrane) that at least partially forms the main spring chamber and the secondary spring chamber. The clastic membrane may be sufficiently elastic to selectively deform in response to a change in pressure of the gas in the main spring chamber and the secondary spring chamber, so as to cause a pressure of a gas in each spring chamber to adjust accordingly. The changing pressure of the gas in the main spring chamber, the secondary spring chamber, or both may control the spring rate of the gas spring.

The embodiments of the present disclosure may provide adjustable control of the spring rate of the gas spring to permit tuning capabilities of a responsiveness of the shock absorbing device. In addition, the secondary spring chamber, being at least partially formed by the clastic membrane, may reduce the number of seals that are exposed to friction, compared to shock absorbing devices that include an additional reservoir and floating piston, which reduces a number of potential failure points of the shock absorbing device.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 illustrates an example mountain bike that includes one example of a shock absorbing device;

FIG. 2A illustrates a perspective view of the example shock absorbing device of FIG. 1, including the shock absorbing device in a default state;

FIG. 2B illustrates a side cross-sectional view of the example shock absorbing device of FIG. 1, including the shock a device in a default state;

FIG. 2C illustrates a bottom cross-sectional view of the example shock absorbing device of FIG. 1;

FIG. 2D illustrates a top cross-sectional view of the example shock absorbing device of FIG. 1;

FIG. 2E illustrates a side cross-sectional view of a portion of the example shock absorbing device of FIG. 1;

FIG. 3 illustrates an exploded view of the example shock absorbing device of FIG. 1; and

FIGS. 4A-4C illustrate side cross-sectional views of the example shock absorbing device of FIG. 1 in different states of compression;

all according to at least one embodiment described in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

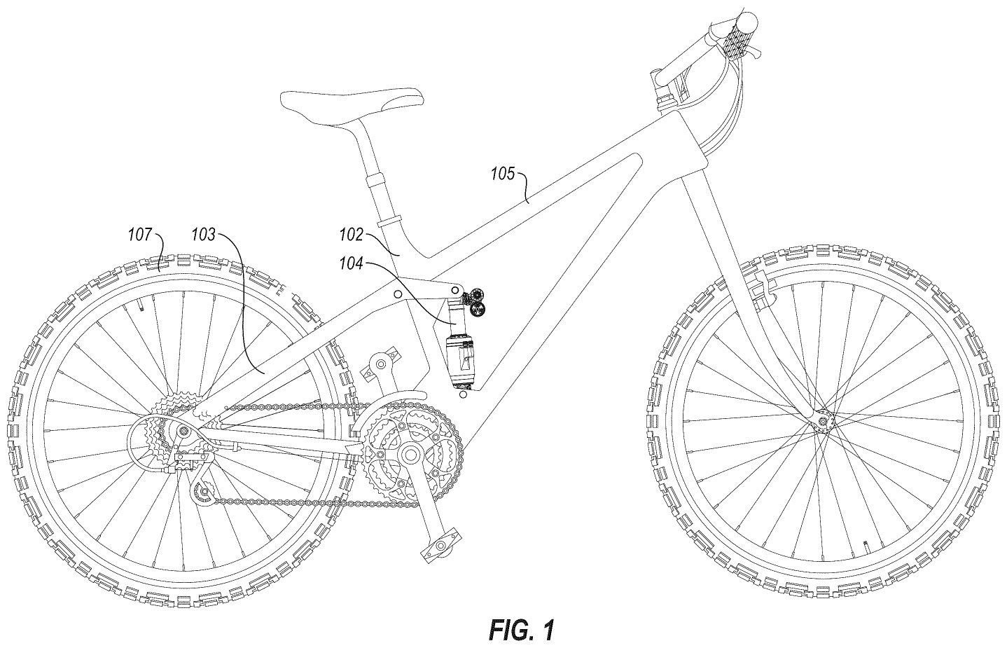

Referring to FIG. 1, an example of one type of vehicle in which aspects of the present disclosure might be used is shown. Shown in FIG. 1 is an embodiment of a mountain bike 102 that includes a shock absorbing device 104. In the example shown, a rear frame 103 of the mountain bike 102 is independent from a front frame 105 of the mountain bike 102 in that they can move independently of each other and are coupled to each other via at least the shock absorbing device 104. While embodiments of the shock absorbing device 104 are described with respect to operation of the mountain bike 102, it will be appreciated that variations of the shock absorbing device 104 can be used with any appropriate vehicle. For example, the shock absorbing device 104 may be used with a motorcycle, scooter, an automobile, aircraft landing gear, or any other appropriate vehicle.

The mountain bike 102 may be designed to be ridden by a user on terrain that includes obstacles such as rocks, boulders, bumps, dirt, mud, sticks, curbs, stairs, or any other appropriate obstacle. The shock absorbing device 104 may be configured to absorb impact forces on a rear wheel 107 of the mountain bike 102. In other words, the shock absorbing device 104 may be configured to reduce an amount the mountain bike 102 shakes or vibrates due to the obstacles. In addition, the shock absorbing device 104 may cause the rear wheel 107 to track the terrain, which may increase traction of the rear wheel 107 compared to a mountain bike without a rear shock.

Some shock absorbing devices include solid, usually metal, springs to store and release energy created by the impact forces on the rear wheel 107. However, the solid springs include set spring rates and are not easily adjusted. In addition, the solid springs may be heavier than gas springs. Some shock absorbing devices include gas springs formed by gas in a main spring chamber. The gas springs may operate by compressing and decompressing the gas in the main spring chamber to store and release energy created by the impact forces on the rear wheel 107. In contrast to the solid springs, the gas springs include adjustable spring rates that are based on an initial pressure of the gas in the main spring chamber. Some of these shock absorbing devices include a spacer positioned in the main spring chamber to reduce a volume of the main spring chamber to control the spring rate of the gas spring. However, a size of the spacer is static, which prevents adjustable control of the spring rate of the gas springs.

Some shock absorbing devices include an additional reservoir or a floating piston that form a secondary chamber to provide adjustable control of the spring rate of the gas springs. However, the additional reservoir and the floating piston may increase a number of seals that create friction during operation of the shock absorbing devices compared to shock absorbing devices that do not include the additional reservoir or the floating piston. The increased number of seals adds complexity and may fail over time.

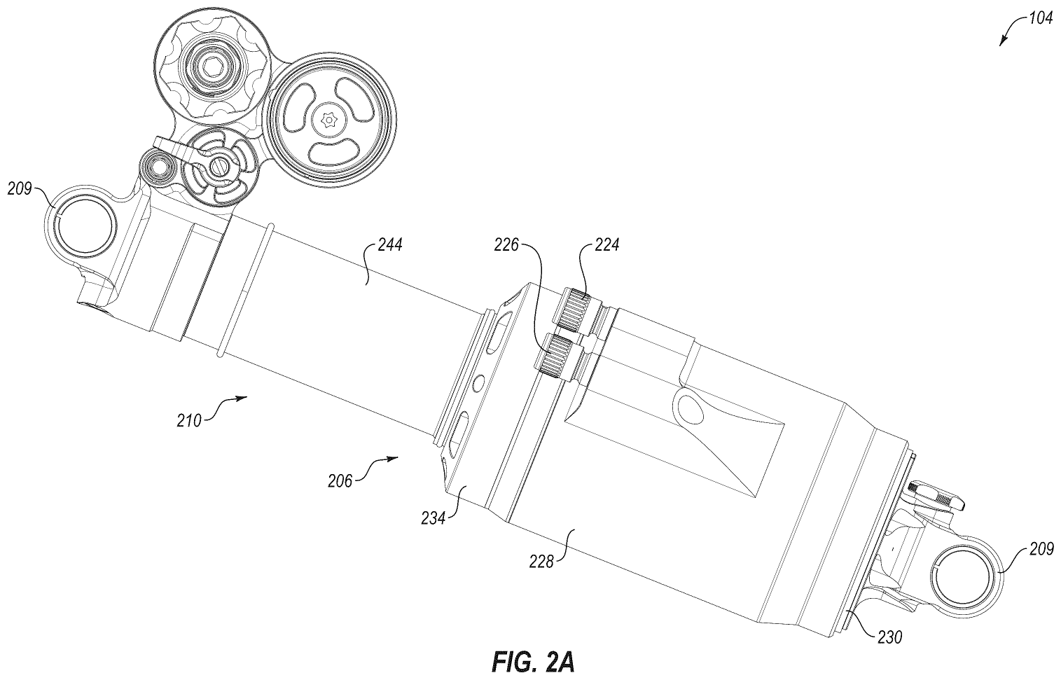

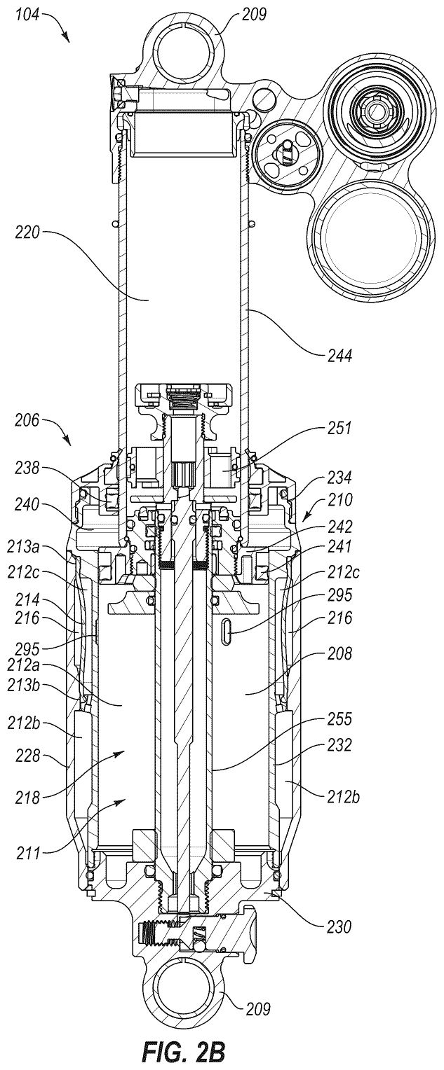

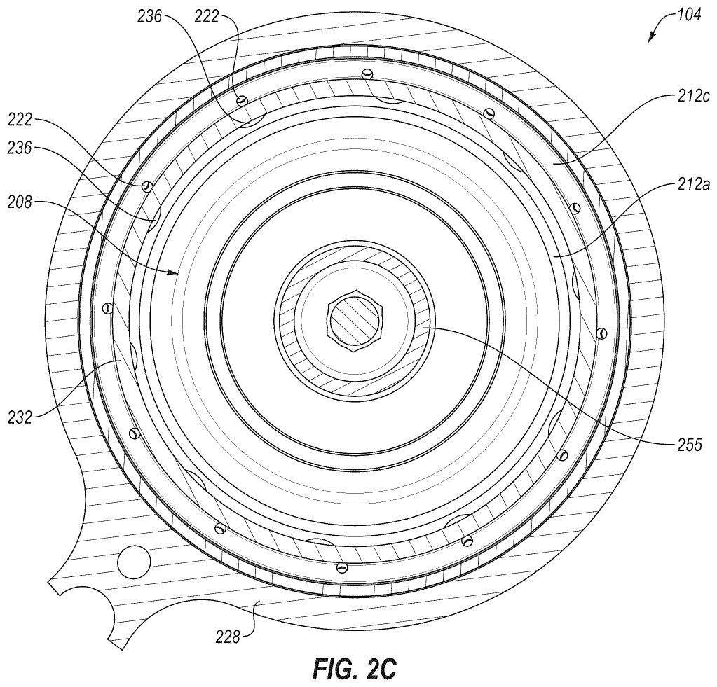

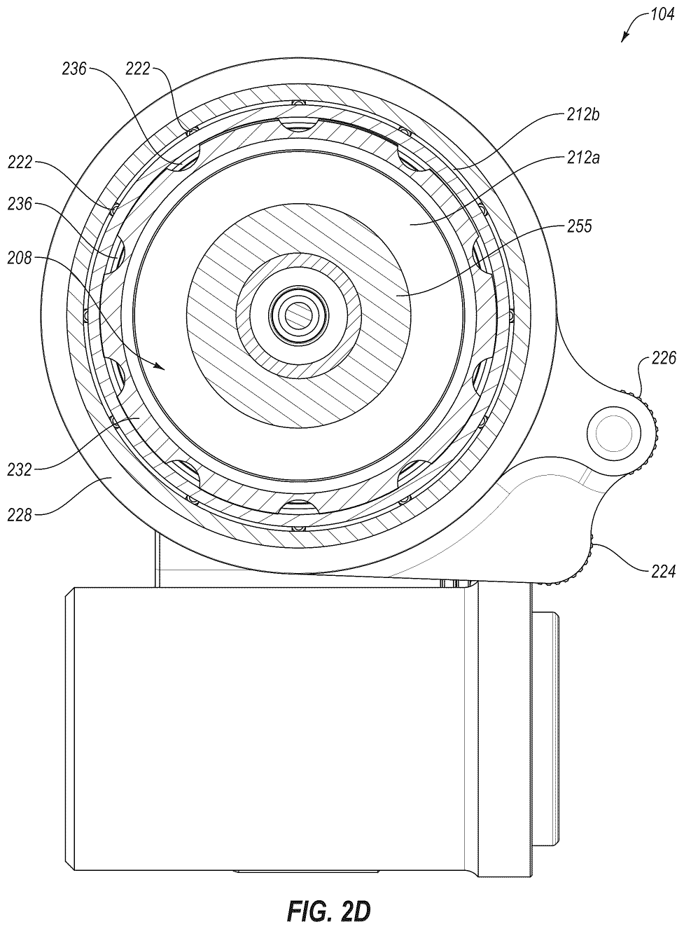

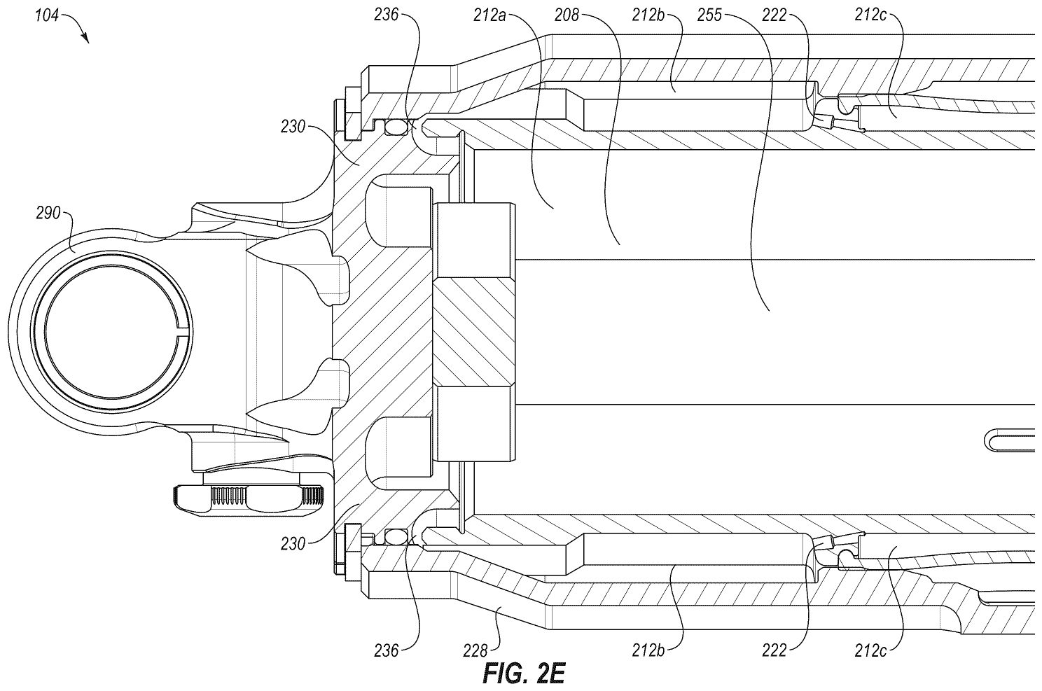

The example shock absorbing device 104 includes a gas spring that is formed by a main spring chamber (such as denoted 211 in FIG. 2B), a secondary spring chamber (such as denoted 216 in FIG. 2B), a negative spring chamber (such as denoted 240 in FIG. 2B), or some combination thereof. The shock absorbing device 104 may provide adjustable control of the spring rate of the gas spring of the shock absorbing device 104 (generally referred to in the present disclosure as “the spring rate of the gas spring”). In the present disclosure, controlling the spring rate of the gas spring means changing, altering, adjusting, or otherwise setting characteristics or responsiveness of the shock absorbing device 104 along one or more portions of the stroke of the shock absorbing device 104.

The shock absorbing device 104 may include an elastic membrane (such as denoted 214 in FIG. 2B) that at least partially defines the main spring chamber 211 and the secondary spring chamber 216. As described in more detail below, the initial pressure of the gases in the secondary spring chamber 216 and the main spring chamber 211 may be set at different pressures and/or adjusted. In addition, as described in more detail below, characteristics of the clastic membrane 214, ratios of the initial pressures of the gases in the main spring chamber 211 and the secondary spring chamber 216, or some combination thereof may permit the shock absorbing device 104 to provide the adjustable control of the spring rate of the gas spring along various portions of the stroke of the shock absorbing device 104. For example, the pressure of the gases in the main spring chamber 211 and secondary spring chamber 216 may be set to control the spring rate of the gas spring at different portions of the stroke for different riding conditions.

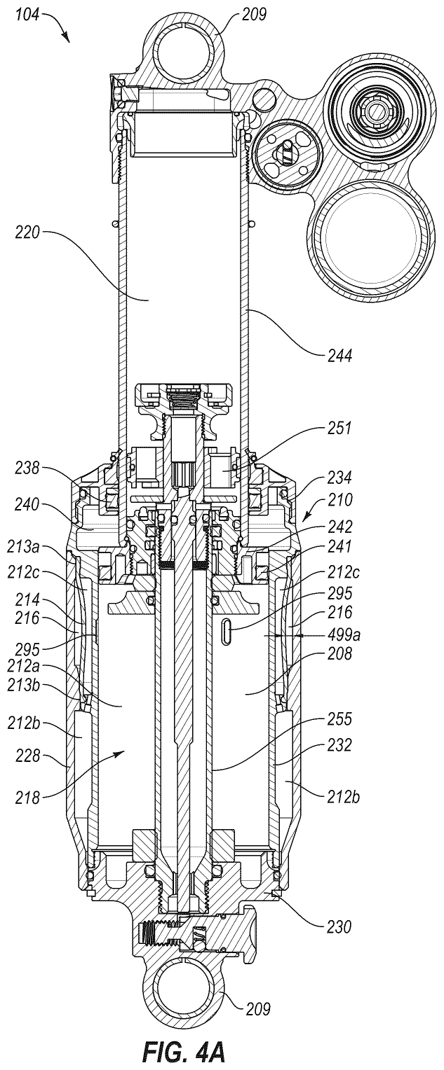

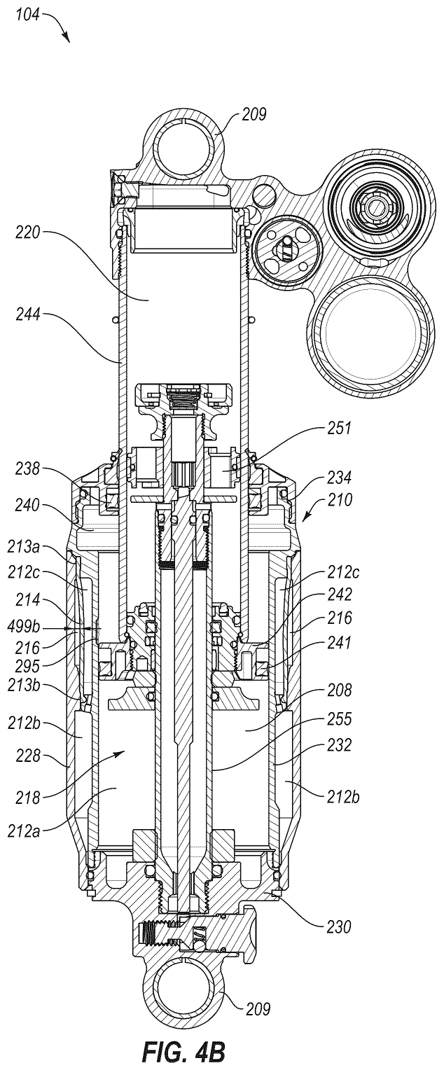

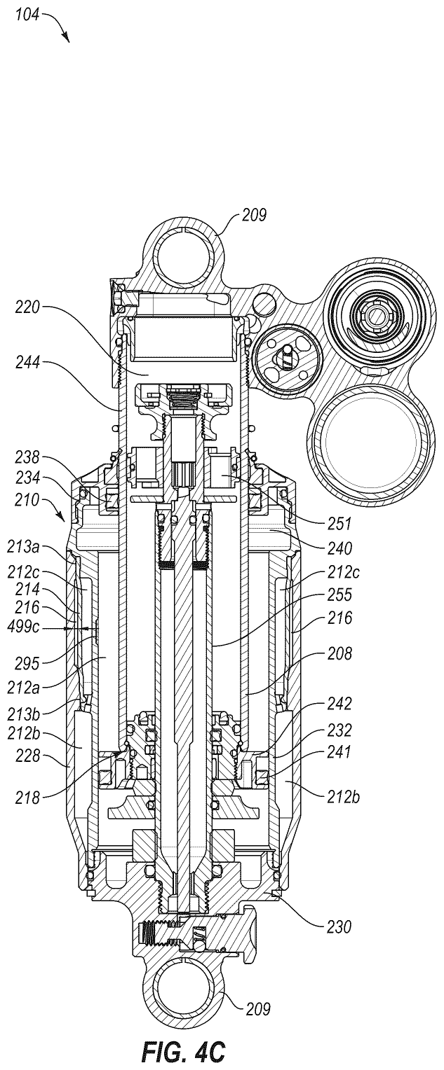

The secondary spring chamber 216 may control the spring rate of the gas spring due to the progressive compression rate of the gas in the main spring chamber 211 being different than the progressive compression rate of the gas in the secondary spring chamber 216 and characteristics of the clastic membrane 214. Stated alternatively, the gas in the secondary spring chamber 216 may compress along different portions of the stroke of the shock absorbing device 104 or at a different rate compared to the gas in the main spring chamber 211. Accordingly, changing the initial pressure of the gas in the secondary spring chamber 216 may cause the spring rate to be more linear or more progressive compared to a shock absorbing device with just a main spring chamber. As used herein, the term “initial pressure” corresponds to pressure of the gases in the main spring chamber 211, the secondary spring chamber 216, or the negative spring chamber with the shock absorbing device 104 in a default or initial state as illustrated and described below in relation to FIG. 4A.

The shock absorbing device 104 may eliminate the use of the spacer making the shock absorbing device 104 readily adjustable for different rider preferences and riding conditions. In addition, as described in more detail below, the clastic membrane 214 defining at least part of the main spring chamber 211 and the secondary spring chamber 216 may permit the shock absorbing device 104 to provide the adjustable control of the spring rate of the gas spring without increasing the number of seals that create friction. Further, the secondary spring chamber 216 not being formed in an additional reservoir may reduce an overall size of the shock absorbing device 104 compared to shock absorbing devices that include the additional reservoir.

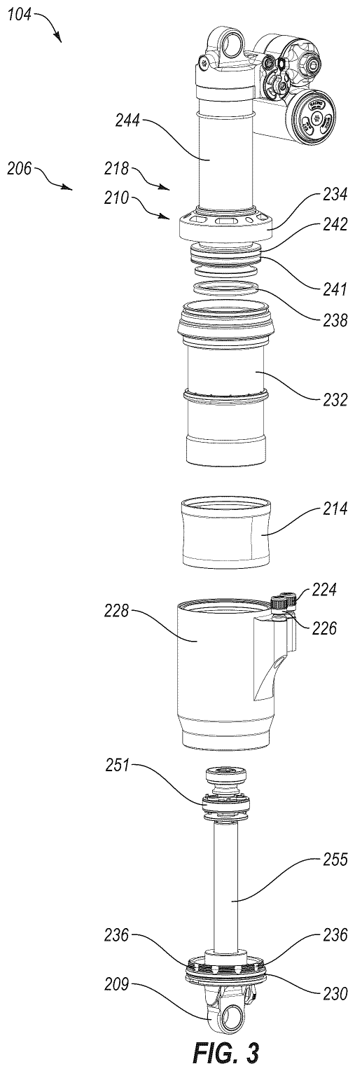

Referring to FIGS. 2A-3, the example shock absorbing device 104 may include a multiple chamber design to control the spring rate of the gas spring. The multiple chambers may include the secondary spring chamber 216, the main spring chamber 211, or the negative spring chamber 240. Gases in the secondary spring chamber 216, the main spring chamber 211, or the negative spring chamber 240 may form the gas spring. In some embodiments, the secondary spring chamber 216 may be in parallel to the main spring chamber 211. Alternatively, the secondary spring chamber 216 may be in series with the main spring chamber 211.

The shock absorbing device 104 may include a housing assembly 206 that includes a first sleeve 228, a first cap 230, a second cap 234, or a second sleeve 232 (shown in FIGS. 2B-2E and 3). The housing assembly 206 may define a housing space 208 (shown in FIGS. 2B-2E) that includes the main spring chamber 211, the secondary spring chamber 216, or the negative spring chamber 240. For example, the first cap 230 or the second cap 234 may be connected to the first sleeve 228 to at least partially define the housing space 208. The second sleeve 232 may be connected to the first cap 230, the second cap 234, or the first sleeve 228. Additionally, the second sleeve 232 may be positioned in the housing space 208.

The housing assembly 206, the elastic membrane 214, or a piston assembly 210 (shown in FIGS. 2B and 3) of the shock absorbing device 104 may at least partially define the main spring chamber 211 in the housing space 208. In addition, the housing assembly 206 or the piston assembly 210 may at least partially define the main spring chamber 211 to include multiple sub-chambers 212a-c (shown in FIGS. 2B-2E) which act to further control the spring and/or damping characteristics of the shock absorbing device 104. In particular, the second sleeve 232, the first cap 230, or the piston assembly 210 may at least partially define (e.g., separate the main spring chamber 211 into) a first sub-chamber 212a; the first sleeve 228, the second sleeve 232, or the first cap 230 may at least partially define a second sub-chamber 212b; or the first sleeve 228, the second sleeve 232, or the elastic membrane 214 may at least partially define a third sub-chamber 212c.

The sub-chambers 212a-c may be fluidly coupled to each other via one or more channels 236 (shown in FIGS. 2B-3) or one or more ports 222 (shown in FIGS. 2C-2E). Specifically, the first sub-chamber 212a may be fluidly coupled to the second sub-chamber 212b via the one or more channels 236. Additionally or alternatively, the second sub-chamber 212b may be fluidly coupled to the third sub-chamber 212c via the one or more ports 222. Only a portion of the channels 236 and the ports 222 are numbered in FIGS. 2B-2E for case of illustration.

The clastic membrane 214 may be positioned in the housing space 208. The housing assembly 206 or the elastic membrane 214 may at least partially define the secondary spring chamber 216 in the housing space 208. In particular, the elastic membrane 214 or the first sleeve 228 may define the secondary spring chamber 216. The elastic membrane 214 may be coupled to the first sleeve 228, the second sleeve 232, or both at connection locations 213a-b (shown in FIG. 2B) to form the secondary spring chamber 216 as a sealed chamber. In other words, the elastic membrane 214 may seal the secondary spring chamber 216 to prevent gas from transferring between the secondary spring chamber 216 and the main spring chamber 211.

The connection locations 213a-b may be static (e.g., not moving) to prevent the elastic membrane 214 from moving relative to the first sleeve 228, the second sleeve 232, or both. The connection locations 213a-b may extend along an entirety of an inner perimeter of the first sleeve 228. Additionally or alternatively, the connection locations 213a-b may extend along an entirety of an outer perimeter of the second sleeve 232.

In some embodiments, the secondary spring chamber 216 may be substantially coaxial with the main spring chamber 211. As used in the present disclosure, substantially coaxial means sharing a common axis or having center axes that are offset from each other no more than 1% of a total length of the shock absorbing device 104. Additionally, the connection points 213a-b being static may prevent a position of the secondary spring chamber 216 from changing relative to the main spring chamber 211. Further, the connection points 213a-b being static may eliminate use of seals that are exposed to friction to form the secondary spring chamber 216.

The housing assembly 206, a damper assembly 218 (shown in its entirety in FIG. 2B), or the piston assembly 210 may at least partially define the negative spring chamber 240 in the housing space 208. In particular, the first sleeve 228, the second sleeve, 232, the second cap 234, the damper assembly 218, or the piston assembly 210 may at least partially define the negative spring chamber 240. In some embodiments, the negative spring chamber 240 may be positioned on an opposite side of a gas piston seal head 242 (shown in FIGS. 2B and 3) of the piston assembly 210 as the main spring chamber 211. In these and other embodiments, the negative spring chamber 240 may be configured to apply pressure on the gas piston seal head 242 that is counter to pressure applied on the gas piston seal head 242 by the main spring chamber 211. For example, an initial pressure or a pressure along the stroke of the shock absorbing device 104 of the gas in the negative spring chamber 240 may be less than the pressure of the gas in the main spring chamber 211.

The piston assembly 210 may include the gas piston seal head 242, a first seal 241 (shown in FIGS. 2B and 3), a second seal 238 (shown in FIGS. 2B and 3), a shaft 255 (shown in FIGS. 2B and 3), or some combination thereof. The gas piston seal head 242, the first seal 241, or the second seal 238 may be positioned in the housing space 208. The first seal 241 may engage with an inner surface of the second sleeve 232, the gas piston seal head 242, or both to prevent gas from transferring between the main spring chamber 211 and the negative spring chamber 240. The second seal 238 may engage with the second cap 234, a tube 244 (shown in FIGS. 2A, 2B, and 3) (e.g. a “damper tube”) of the damper assembly 218, or both to prevent gas in the negative spring chamber 240 from exiting the negative spring chamber 240 or gas external to the shock absorbing device 104 from entering the negative spring chamber 240.

The damper assembly 218 may include the tube 244 and a circuit assembly 251 (shown in FIGS. 2B and 3). The gas piston seal head 242 may engage with the shaft 255 within the housing space 208. In addition, the gas piston seal head 242 may be configured to engage with and move along a surface of the shaft 255. Further, the gas piston seal head 242 may be configured to engage with and move along the inner surface of the second sleeve 232.

The tube 244 may be positioned at least partially external to the housing space 208, partially within the housing space 208, or both. In some embodiments, the tube 244 may be coupled to or otherwise engage the gas piston seal head 242. In these and other embodiments, as described in more detail below, the tube 244 may be configured to apply a force on the gas piston seal head 242 to move the gas piston seal head 242. The gas piston seal head 242 may cause the first seal 241 to move within the housing space 208.

The tube 244 or the gas piston seal head 242 may at least partially define a fluid chamber 220. In some embodiments, the fluid chamber 220 may be coaxial with the main spring chamber 211, the secondary spring chamber 216, or both. The circuit assembly 251 may include a high-speed compression circuit, a low-speed compression circuit, one or more rebound circuits, or some combination thereof. The circuit assembly 251 may be positioned within the fluid chamber 220 and engage an inner surface of the tube 244. In some embodiments, the fluid chamber 220 may house a fluid that is configured to traverse the various circuits of the circuit assembly 251 during operation of the shock absorbing device 104 to dissipate energy and regulate the rate of change of the shock absorbing device 104 along the stroke.

The shock absorbing device 104 may include a first valve 226 (e.g., gas inflation valve) or a second valve 224 (e.g., gas inflation valve). The first valve 226 may be fluidly coupled to the main spring chamber 211. Additionally, the second valve 224 may be fluidly coupled to the secondary spring chamber 216. An initial pressure of the gas in the main spring chamber 211 may be adjustable via the first valve 226. Additionally or alternatively, the initial pressure of the gas in the main spring chamber 211 may be adjustable or otherwise impacted by the initial pressure of the gas in the secondary spring chamber 216. In addition, an initial pressure of the gas in the secondary spring chamber 216 may be adjustable via the second valve 224. Additionally or alternatively, the initial pressure of the gas in the secondary spring chamber 216 may be adjustable or otherwise impacted by the initial pressure of the gas in the main spring chamber 211. Accordingly, the pressure of the gases in the main spring chamber 211 and the secondary spring chamber 216 may be set and/or adjusted to the same or different pressures, affecting the spring rate curve.

A pump (e.g., a shock pump, bicycle pump, or any appropriate pump) (not shown) may be connected to the first valve 226. The pump may force gas into the main spring chamber 211 (e.g., the main spring chamber 211 may receive gas via the first valve 226) to increase the initial pressure of the gas in the main spring chamber 211. Alternatively, a core of the first valve 226 may be pressed without the pump being connected to release gas from the main spring chamber 211.

The ports 222 or the channels 236 may permit gas to pass between the sub-chambers 212a-c to cause the pressure of the gas in the different sub-chambers 212a-c to be adjusted. Accordingly, the initial pressure of the gas in the main spring chamber 211 may be set.

In some embodiments, the initial pressure of the gas in the negative spring chamber 240 may be statically set at assembly. In other embodiments, the initial pressure of the gas in the negative spring chamber 240 may be adjusted by adjusting the initial pressure of the gas in the main spring chamber 211 and cycling the shock absorbing device 104, such that the first seal 241 moves past negative chamber supply ports 295.

The pump may be connected to the second valve 224. The pump may force gas into the secondary spring chamber 216 (e.g., the secondary spring chamber 216 may receive gas via the second valve 224) to increase the initial pressure of the gas in the secondary spring chamber 216. Alternatively, a core of the second valve 224 may be pressed without the pump being connected to release gas from the secondary spring chamber 216. Accordingly, the initial pressure of the gas in the secondary spring chamber 216 may be set.

The mountain bike 102 may apply a pushing force or a pulling force on the shock absorbing device 104 via one or more links 209. When the pushing force is applied on the links 209, the tube 244 may apply the force on the gas piston seal head 242 to cause the shock absorbing device 104 to move along the stroke and compress. When the pushing force is removed or the pulling force is applied on the links 209, the tube 244 may move in an opposite direction and cause the shock absorbing device 104 to move along the stroke in an opposite direction and decompress.

The piston assembly 210 may be configured to move within the housing space 208 to adjust the pressure of the gas in the main spring chamber 211. In particular, when the shock absorbing device 104 is being compressed, the gas piston seal head 242 may move within the housing space 208 to reduce a volume of the main spring chamber 211 (e.g., a volume of the first sub-chamber 212a) and increase the pressure of the gas in the main spring chamber 211. Additionally or alternatively, when the shock absorbing device 104 is being decompressed, the gas piston seal head 242 may move within the housing space 208 to increase a volume of the main spring chamber 211 to decrease the pressure of the gas in the main spring chamber 211.

When the gas piston seal head 242 is moving, the first seal 241 may also move along and engage with the inner surface of the second sleeve 232 to prevent gas from moving between the main spring chamber 211 and the negative spring chamber 240. When the tube 244 is moving, the second seal 238 may be static and the tube 244 may move relative to the second seal 238. Additionally, the second seal 238 may prevent gas from moving between the negative spring chamber 240 and an external environment.

When the shock absorbing device 104 is being compressed, the channels 236 may permit gas in the first sub-chamber 212a to enter the second sub-chamber 212b. Additionally, when the shock absorbing device 104 is being compressed, the ports 222 may permit gas in the second sub-chamber 212b to enter the third sub-chamber 212c. Accordingly, the pressure of the gas in the sub-chambers 212a-c (e.g., the main spring chamber 211) may be increased during operation of the shock absorbing device 104.

Alternatively, when the shock absorbing device 104 is being decompressed, the channels 236 may permit gas in the second sub-chamber 212b to enter the first sub-chamber 212a. Additionally, when the shock absorbing device 104 is being decompressed, the ports 222 may permit gas in the third sub-chamber 212c to enter the second sub-chamber 212b. Accordingly, the pressure of the gas in the sub-chambers 212a-c (e.g., the main spring chamber 211) may be decreased during operation of the shock absorbing device 104.

In some embodiments, the ports 222 may be configured to regulate a flow of the gas between the second sub-chamber 212b and the third sub-chamber 212c. The ports 222 may regulate the flow of the gas based on operating parameters of the shock absorbing device 104. For example, the ports 222 may permit the gas to flow at a particular rate based on a velocity, phase change frequency, or both of compression and/or decompression of the shock absorbing device 104. In some embodiments, if the flow rate of the gas between the second sub-chamber 212b and the third sub-chamber 212c exceeds a threshold flow rate, determined as a function of main and secondary spring rates, the ports 222 may close to prevent gas from flowing to control the spring rate of the gas spring.

In some embodiments, the ports 222 may include ports (e.g., pressure ports or pressure dependent ports) that regulate the flow of the gas between the second sub-chamber 212b and the third sub-chamber 212c to regulate when the clastic membrane 214 selectively deforms (e.g., regulate activation or deactivation of the secondary spring chamber 216). A number, a shape, a dimension, or some combination thereof of the ports 222 may regulate the flow of the gas to regulate when the clastic membrane 214 selectively deforms. For example, the number or dimensions of the ports 222 may be increased to cause the clastic membrane 214 to selectively deform and compress the secondary spring chamber 216 sooner compared to a fewer number or smaller dimensioned ports 222.

Further, the ports 222 may regulate the flow of the gas between the second sub-chamber 212b and the third sub-chamber 212c to control an impact that the secondary spring chamber 216 has on the spring rate of the gas spring. In other words, the ports 222 may control the flow rate of gas between the second sub-chamber 212b and the third sub-chamber 212c to control the spring rate of the gas spring.

In some embodiments, the ports 222 may control the flow rate of the gas between the second sub-chamber 212b and the third sub-chamber 212c to dissipate energy and control the rate of change of the shock absorbing device 104 (e.g., the ports 222 may operate as an at least partial damping system for the shock absorbing device 104). The size, the shape, the number, or some combination thereof of the ports 222 may control how much of a damping effect the ports 222 provide. For example, the number or dimensions of the ports 222 may be decreased to provide more of a damping effect or the number or dimensions of the ports 222 may be increased to provide less of a damping effect.

The pressure of the gas in the main spring chamber 211 (e.g., the pressure of the gas in the third sub-chamber 212c) changing may change an amount of force applied on the elastic membrane 214. For example, the pressure of the gas in the main spring chamber 211 increasing may cause the force applied on the elastic membrane 214 to increase. As another example, the pressure of the gas in the main spring chamber 211 decreasing may cause the force applied on the elastic membrane 214 to decrease.

In some embodiments, a default position of the elastic membrane 214 may be based on the initial pressure of the gas in the secondary spring chamber 216, the main spring chamber 211, or both. Additionally, the elastic membrane 214 may be sufficiently elastic such that the pressure applied on the clastic membrane 214 may cause the elastic membrane 214 to selectively deform and change a volume of the secondary spring chamber 216, a volume of the main spring chamber 211, or both. For example, increasing the pressure applied on the elastic membrane 214 may cause the elastic membrane 214 to selectively deform and urge the clastic membrane 214 towards the first sleeve 228 to reduce the volume of the secondary spring chamber 216, increase the volume of the main spring chamber 211, or both. As another example, decreasing the pressure applied on the elastic membrane 214 may cause the clastic membrane 214 to selectively deform and pressure of the gas in the secondary spring chamber 216 may urge the clastic membrane 214 away from the first sleeve 228 to increase the volume of the secondary spring chamber 216, decrease the volume of the main spring chamber 211, or both.

A rate at which the clastic membrane 214 is urged towards or away from the first sleeve 228 (e.g., a rate the clastic membrane 214 selectively deforms) may be based on the initial pressure of the gas in the secondary spring chamber 216, the initial pressure of the gas in the main spring chamber 211, characteristics of the clastic membrane 214, or some combination thereof. For example, the rate at which the clastic membrane 214 is urged towards the first sleeve 228 may be increased by decreasing the initial pressure of the gas in the secondary spring chamber 216, the elastic membrane 214 including a softer or more pliable material, or increasing the initial pressure of the gas in the main spring chamber 211. As another example, the rate at which the elastic membrane 214 is urged away from the first sleeve 228 may be increased by increasing the initial pressure of the gas in the secondary spring chamber 216, the elastic membrane 214 including a more rigid material, or decreasing the initial pressure of the gas in the main spring chamber 211.

In some embodiments, the clastic membrane 214 may be configured to selectively deform and reduce the volume of the secondary spring chamber 216, increase the volume of the main spring chamber 211, or both when the force applied on the elastic membrane 214 by the gas in the main spring chamber 211 exceeds a first threshold value. The first threshold value may be based on the initial pressure of the gas in the secondary spring chamber 216, a material of the elastic membrane 214, or one or more characteristics of the clastic membrane 214. For example, the first threshold value may increase as a value of the initial pressure of the gas in the secondary spring chamber 216 increases. As another example, the first threshold value may decrease as a rigidness of the elastic membrane 214 decreases.

The clastic membrane 214 may be configured to selectively deform and increase the volume of the secondary spring chamber 216, decrease the volume of the main spring chamber 211, or both when the force applied on the elastic membrane 214 by the gas in the main spring chamber 211 is less than a second threshold value. The second threshold value may be based on the initial pressure of the gas in the secondary spring chamber 216, the material of the clastic membrane 214, or the one or more characteristics of the clastic membrane 214.

The rate at which the clastic membrane 214 is urged towards or away from the first sleeve 228 may control a rate at which the gas in the secondary spring chamber 216 changes. The rate at which the gas in the secondary spring chamber 216 changes may control the spring rate of the gas spring along a portion of the stroke of the shock absorbing device. Additionally or alternatively, the amount of force applied on the clastic membrane 214 before the elastic membrane 214 selectively deforms may regulate when the secondary spring chamber 216 controls the spring rate of the gas spring.

Accordingly, the initial pressure of the gas in the secondary spring chamber 216, the characteristics of the clastic membrane 214, or both may control the spring rate of the gas spring. The characteristics of the clastic membrane 214 may include a surface characteristic, a substance characteristic, a dimensional characteristic, a shape characteristic, a material characteristic, or any other appropriate characteristic of the clastic membrane 214. In some embodiments, the portion of the stroke of the shock absorbing device 104 that the clastic membrane 214 selectively deforming controls (e.g., the secondary spring chamber 216) is adjustable by changing the initial pressure of the gas in the main spring chamber 211, the initial pressure of the gas in the secondary spring chamber 216, one or more characteristics of the clastic membrane 214, or some combination thereof.

In some embodiments, the clastic membrane 214 may resist applied forces and control the spring rate of the gas spring based on the initial pressure of the gas in the secondary spring chamber 216, a velocity of the rate of the change of the shock absorbing device, the frequency of compression and/or decompression of the shock absorbing device 104, or some combination thereof. The clastic membrane 214 may be configured to resist applied forces and control the spring rate of the gas spring based on at least one of the initial pressure of the gas in the main spring chamber 211 (e.g., the pressure of the gas in the main spring chamber 211 in a default position of the piston assembly 210), the initial pressure of the gas in the secondary spring chamber 216 (e.g., the pressure of the gas in the secondary spring chamber 216 in the default position of the piston assembly 210, an amount of travel of the shock absorbing device 104 (e.g., the piston assembly 210) along the stroke; or a velocity of travel of the piston assembly 210.

When the shock absorbing device 104 is being compressed, the gas piston seal head 242 may move away from the second cap 234 and increase the volume of the negative spring chamber 240. The volume of the negative spring chamber 240 increasing may cause the pressure of the gas in the negative spring chamber 240 to decrease. Additionally or alternatively, when the shock absorbing device 104 is being decompressed, the gas piston seal head 242 may move towards the second cap 234 and decrease the volume of the negative spring chamber 240. The volume of the negative spring chamber 240 decreasing may cause the pressure of the gas in the negative spring chamber 240 to increase. Accordingly, the negative spring chamber 240 may apply a counter pressure on the gas piston seal head 242 compared to the pressure applied on the gas piston seal head 242 by the main spring chamber 211. For example, the pressure of the gas in the negative spring chamber 240 may decrease when the pressure in the main spring chamber 211 increases.

During operation of the shock absorbing device 104, the tube 244 may move relative to the circuit assembly 251 to force fluid in the fluid chamber 220 through the various circuits of the circuit assembly 251 to dissipate energy and control a rate of change of the shock absorbing device 104 (e.g., how quickly the shock absorbing device 104 can oscillate between being compressed and decompressed). In other words, the damper assembly 218 may dampen how quickly the gas spring compresses and rebounds.

The tube 244 moving may change a volume of a portion of the fluid chamber 220 positioned between the circuit assembly 251 and an upper link 209 and a volume of a portion of the fluid chamber 220 positioned between the circuit assembly 251 and the gas piston seal head 242. When the volume of the portions of the fluid chamber 220 changes, at least a portion of the fluid in the fluid chamber 220 may traverse the circuit assembly 251 to move between the different portions. The various circuits of the circuit assembly 251 may regulate how quickly the fluid can traverse the circuit assembly 251, which may regulate how quickly the tube 244, the gas piston seal head 242, or both can change direction. An example of the tube 244 moving and changing the volume of the portions of the fluid chamber 220 is shown in relation to FIGS. 4A-4C.

Accordingly, the main spring chamber 211 may provide general support of the shock absorbing device 104 and the main spring chamber 211 in combination with the secondary spring chamber 216 may control the spring rate of the gas spring. Additionally, the main spring chamber 211 may control a sensitivity of one or more portions of the stroke of the shock absorbing device 104 and the secondary spring chamber 216 may control the sensitivity of one or more portions of the stroke of the shock absorbing device 104. For example, the initial pressure of the gas in the main spring chamber 211 may control a top stroke portion or a mid-stroke portion of the shock absorbing device 104 (e.g., a dynamic sag position of the shock absorbing device 104) and the initial pressure of the secondary spring chamber 216 may control an end stroke portion of the shock absorbing device 104.

The ports 222 are shown in FIG. 2E as including two cylindrical recesses with different diameters for example purposes. It is understood that the ports 222 may include different sizes, shapes, dimensions, or any other appropriate aspect. For example, the cylindrical recess with the larger diameter may be coupled to the third sub-chamber 212c instead of the second sub-chamber 212b. As another example, a cross-sectional shape of one or more of the ports 222 may include a triangular shape, a rectangular shape, a square shape, or any other appropriate shape.

Alternatively, the ports 222 may be omitted and the second sub-chamber 212b and the third sub-chamber 212c may form a single chamber. The ports 222 may include any appropriate shape, size, dimension, or some combination thereof to control the flow rate of the gas between the second sub-chamber 212b and the third sub-chamber 212c.

The elastic membrane 214 is shown in FIGS. 2B, 2E, and 3 as including a smooth surface for example purposes. The clastic membrane 214 may include any appropriate surface characteristic. For example, the elastic membrane 214 may include a dimpled surface, a rough surface, or any other appropriate surface. The elastic membrane 214 may include a rubber material, a plastic material, a metal material, or any other appropriate elastic material.

The elastic membrane 214 is illustrated as circumscribing a portion of an outer perimeter of the main spring chamber 211 for example purposes. The elastic membrane 214 may circumscribe any appropriate amount of the corresponding perimeter. For example, the elastic membrane 214 may circumscribe a portion of an inner perimeter of third sub-chamber 212c. The clastic membrane 214 is illustrated as extending along an entirety of the portion of the outer perimeter of the main spring chamber 211 for example purposes. The clastic membrane 214 may extend along only a portion of the outer perimeter or any corresponding perimeter.

A length of the secondary spring chamber 216 (e.g., the left and right direction in FIG. 2B), the elastic membrane 214, or both may be changed to adjust a possible volume of the secondary spring chamber 216. For example, the length of the elastic membrane 214 may be increased to increase a possible radius of curvature of the clastic membrane 214 to increase the possible volume of the secondary spring chamber 216. The clastic membrane 214 is shown as being positioned proximate the second cap 234 for example purposes. The clastic membrane 214 may be in any appropriate position within the housing space 208. For example, the elastic membrane 214 may be positioned proximate the first cap 230 and at least partially define the second sub-chamber 212b.

The gases in the main spring chamber 211, the secondary spring chamber 216, or the negative spring chamber 240 may include air, nitrogen, or any other appropriate compressible gas. In some embodiments, the gas in the main spring chamber 211 may be different than the gas in the secondary spring chamber 216. In some embodiments, the secondary spring chamber 216 may be filled with a non-compressible gas to reduce the secondary spring chamber 216 volume and statically control the spring rate of the gas spring.

In some embodiments, the shock absorbing device 104 may include one more of a spacer, a liquid (e.g., oils) filled via the valves 224 or 226 or otherwise, or any other appropriate component in the main spring chamber 211, the secondary spring chamber 216, or both. In these and other embodiments, the spacer, the liquid, or any other appropriate component may reduce the volume of the corresponding spring chamber that can be filled with the gas. Additionally or alternatively, reducing the volumes of the main spring chamber 211, the secondary spring chamber 216, or both may cause the spring rate of the gas spring to be more progressive compared the gas spring when the shock absorbing device 104 does not include the one or more spacers, fluids, or any other appropriate component in the main spring chamber 211, the secondary spring chamber 216, or both.

Referring to FIGS. 4A-4C, the example shock absorbing device 104 is illustrated along different portions of the stroke of the shock absorbing device 104 (e.g., in different states of compression). FIG. 4A illustrates the example shock absorbing device 104 in the default state or uncompressed state (e.g., the top stroke). FIG. 4B illustrates the example shock absorbing device 104 in an intermediate state or transition state (e.g., the mid-stroke). FIG. 4C illustrates the example shock absorbing device 104 in a fully compressed state (e.g., the end stroke).

In the default state (e.g., FIG. 4A), the initial pressure of the gases in the main spring chamber 211, the secondary spring chamber 216, or both may be set using a pump and the valves 224 or 226. The initial pressures of the gases in the main spring chamber 211, the secondary spring chamber 216, or both may be set to control the spring rate of the gas spring. For example, the pressure of the gas in the main spring chamber 211 may be set lower to provide an overall progressive spring rate of the gas spring and the pressure of the gas in the secondary spring chamber 216 may be set higher to make the spring rate of the gas spring along a particular portion of the stroke more progressive. The clastic membrane 214 is shown in an example default state in FIG. 4A with a first distance 499a between the clastic membrane 214 and the first sleeve 228.

The shock absorbing device 104 in the intermediate state (e.g., FIG. 4B) may be transitioning from the default state to a more compressed state (e.g., FIG. 4C) or from the more compressed state to the default state. In some embodiments, the intermediate state may be at the end of a compression of the shock absorbing device 104 due to an obstacle and the shock absorbing device 104 may transition back to the default state.

In the intermediate state, the tube 244 may urge the gas piston seal head 242 towards or away from the second cap 234 to increase or decrease the pressure of the gas in the main spring chamber 211. In the intermediate state, the volume of the main spring chamber 211 may be reduced compared to the default state. Accordingly, the pressure of the gas in the main spring chamber 211 may be increased in the intermediate state compared to the default state. In addition, the volume of the negative spring chamber 240 may be increased compared to the default state. Accordingly, the pressure of the gas in the negative spring chamber 240 may be decreased in the intermediate state compared to the default state.

The reduced volume of the main spring chamber 211 may increase the pressure of the gas in the main spring chamber 211 and the amount of force applied on the clastic membrane 214 compared to the default state. The increased force applied on the clastic membrane 214 may urge the clastic membrane 214 towards the first sleeve 228. The clastic membrane 214 being urged towards the first sleeve 228 may reduce the volume of the secondary spring chamber 216 compared to the default state. The reduced volume of the secondary spring chamber 216 is shown by a second distance 499b between the clastic membrane 214 and the first sleeve 228 being shorter than the first distance 499a.

In the intermediate state, the tube 244 has moved relative to the circuit assembly 251 compared to the default state. When moving, the tube 244, the gas piston seal head 242, or both may force fluid in the fluid chamber 220 to traverse the circuit assembly 251. The fluid traversing the circuit assembly 251 may dissipate energy to regulate the rate of change of the shock absorbing device 104. In the intermediate state, the portion of the fluid chamber 220 that is to the left of the circuit assembly 251 in FIG. 4B is greater than in the default state shown in FIG. 4A.

Alternatively, in the intermediate state, the volume of the main spring chamber 211 may be increased compared to the compressed state shown in FIG. 4C. Accordingly, the pressure of the gas in the main spring chamber 211 may be decreased in the intermediate state compared to the compressed state. In addition, the volume of the negative spring chamber 240 may be decreased compared to the compressed state. Accordingly, the pressure of the gas in the negative spring chamber 240 may be increased in the intermediate state compared to the compressed state.

In the fully compressed state (e.g., FIG. 4C), the shock absorbing device 104 may be at the end of a compression of the shock absorbing device 104 due to an obstacle impact and the shock absorbing device 104 or at the end portion of the stroke and may transition back towards the intermediate state.

In the compressed state, the tube 244 has urged the gas piston seal head 242 away from the second cap 234 to reduce the volume of the main spring chamber 211 compared to the intermediate state. Accordingly, the pressure of the gas in the main spring chamber 211 may be increased in the compressed state compared to the intermediate state. In addition, the volume of the negative spring chamber 240 may be increased compared to the intermediate state. Accordingly, the pressure of the gas in the negative spring chamber 240 may be decreased in the compressed state compared to the intermediate state.

The reduced volume of the main spring chamber 211 may increase the pressure of the gas in the main spring chamber 211 and the amount of force applied on the clastic membrane 214 compared to the intermediate state. The increased force applied on the clastic membrane 214 may urge the clastic membrane 214 towards the first sleeve 228 more than in the intermediate state. The clastic membrane 214 being urged more towards the first sleeve 228 may reduce the volume of the secondary spring chamber 216 compared to the intermediate state. The reduced volume of the secondary spring chamber 216 is shown by a third distance 499c between the clastic membrane 214 and the first sleeve 228 being shorter than the second distance 499b.

In the compressed state, the tube 244 has moved relative to the circuit assembly 251 compared to the intermediate state. When moving, the tube 244, the gas piston seal head 242, or both may force fluid in the fluid chamber 220 to traverse the circuit assembly 251. The fluid traversing the circuit assembly 251 may dissipate energy to regulate the rate of change of the shock absorbing device 104. In the compressed state, the portion of the fluid chamber 220 that is to the left of the circuit assembly 251 in FIG. 4C is greater than in the intermediate state shown in FIG. 4B.

During the operation, the shock absorbing device 104 may repeatedly transition between the default state, the intermediate state, or the compressed state to reduce shakes or vibrations and the effects on impacts to the wheels of the mountain bike.

It is to be understood that the figures are diagrammatic and schematic representations of such example embodiments, and are not limiting, nor are they necessarily drawn to scale. In the figures, features with like numbers indicate like structure and function unless described otherwise.

As used in the present disclosure, terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A shock absorbing device comprising:
a housing assembly that defines a housing space;
a piston assembly configured to move within the housing space to adjust a pressure of a gas in a main spring chamber to form a gas spring, wherein the piston assembly and the housing assembly partially define the main spring chamber within the housing space; and
an elastic membrane positioned in the housing space, with the housing assembly and the elastic membrane defining a secondary spring chamber within the housing space and the elastic membrane partially defines the main spring chamber; and
wherein the elastic membrane is sufficiently elastic such that when the movement of the piston assembly changes the pressure of the gas in the main spring chamber, a force applied on the elastic membrane by the gas in the main spring chamber changes and causes the elastic membrane to selectively deform to adjust volumes of the main spring chamber and the secondary spring chamber and to adjust pressures of gases in the main spring chamber and the secondary spring chamber to control a spring rate of the gas spring along a portion of a stroke of the piston assembly.

2. The shock absorbing device of claim 1 further comprising a damper assembly defining a fluid chamber, wherein:
the main spring chamber and the secondary spring chamber are coaxial with the fluid chamber; and
the fluid chamber is configured to dissipate energy and control a rate of change of the piston assembly.

3. The shock absorbing device of claim 1, wherein the main spring chamber and the secondary spring chamber are coaxial.

4. The shock absorbing device of claim 1, wherein the main spring chamber comprises a first sub-chamber and a second sub-chamber that are fluidly coupled via a port.

5. The shock absorbing device of claim 4, wherein the port is configured to control a rate that a gas transfers between the first sub-chamber and the second sub-chamber to control at least one of:
a rate of change of the piston assembly; or
the spring rate of the gas spring.

6. The shock absorbing device of claim 1, wherein:
the main spring chamber is configured to receive the gas via a first gas inflation valve; and
the secondary spring chamber is configured to receive the gas a second gas inflation valve.

7. The shock absorbing device of claim 1, wherein the elastic membrane is configured to resist force and control the spring rate of the shock absorbing device at a rate based on at least one of:
an initial pressure of the gas in the main spring chamber;
an initial pressure of the gas in the secondary spring chamber;
an amount of travel of the piston assembly along the stroke; or
a velocity of travel of the piston assembly.

8. The shock absorbing device of claim 1, wherein the housing assembly comprises:
a first sleeve;
a first cap connected to the first sleeve, wherein the first sleeve and the first cap partially define the housing space; and
a second sleeve at least partially positioned within the housing space and connected to the first cap and the first sleeve.

9. The shock absorbing device of claim 8, wherein:
the second sleeve separates the main spring chamber into a plurality of sub-chambers; and
the first cap and the second sleeve define a channel that fluidly couples the plurality of sub-chambers.

10. The shock absorbing device of claim 1, further comprising:
a first seal engaged with the housing assembly, wherein the first seal moves with the piston assembly such that the first seal prevents at least one of:
the gas in the main spring chamber from exiting the main spring chamber; or
a gas in a negative spring chamber from entering the main spring chamber;
a second seal engaged with the housing assembly and a damper assembly, wherein the damper assembly moves relative to the second seal prevents at least one of:
the gas in the negative spring chamber from exiting the negative spring chamber; or
a gas external to the shock absorbing device to enter the negative spring chamber.

11. The shock absorbing device of claim 1, wherein:
the piston assembly is configured to move within the housing space to change the volume of the main spring chamber to adjust the pressure of the gas in the main spring chamber; and
the elastic membrane is configured to selectively deform to change the volumes of the main spring chamber and the secondary spring chamber to adjust the pressures of the gases in the main spring chamber or the secondary spring chamber.

12. The shock absorbing device of claim 1, wherein the elastic membrane selectively deforms when an amount of the force applied on the elastic membrane by the gas in the main spring chamber exceeds a threshold value.

13. The shock absorbing device of claim 1, wherein the portion of the stroke of the piston assembly that the elastic membrane selectively deforming controls the spring rate of the gas spring is adjustable by changing an initial pressure of the gas in the main spring chamber or an initial pressure of the gas in the secondary spring chamber.

14. A shock absorbing device comprising:
a housing assembly that defines a housing space;
a piston assembly configured to move within the housing space to adjust a pressure of a gas in a main spring chamber to form a gas spring, wherein the piston assembly and the housing assembly partially define the main spring chamber within the housing space;
a damper assembly defining a fluid chamber configured to control a rate of change of the shock absorbing device; and
an elastic membrane positioned in the housing space, the housing assembly and the elastic membrane defining a secondary spring chamber within the housing space and the elastic membrane partially defines the main spring chamber;
wherein:
the main spring chamber, the secondary spring chamber, or the fluid chamber are coaxial; and
the elastic membrane is sufficiently elastic such that when the movement of the piston assembly changes the pressure of the gas in the main spring chamber, a force applied on the elastic membrane by the gas in the main spring chamber changes and causes the elastic membrane to selectively deform to adjust volumes of the main spring chamber and the secondary spring chamber and to adjust pressures of gases in the main spring chamber and the secondary spring chamber to control a spring rate of the gas spring along a portion of a stroke of the piston assembly.

15. The shock absorbing device of claim 14, wherein the main spring chamber comprises a first sub-chamber and a second sub-chamber and the shock absorbing device comprises a port that fluidly couples the first sub-chamber and the second sub-chamber.

16. The shock absorbing device of claim 15, wherein the port is configured to control a rate that a gas transfers between the first sub-chamber and the second sub-chamber to control at least one of:
a rate of change of the piston assembly; or
the spring rate of the gas spring.

17. The shock absorbing device of claim 14, wherein:
the pressure of the gas in the main spring chamber in a default position of the piston assembly is adjustable via a first gas inflation valve; and
the pressure of the gas in the secondary spring chamber in the default position of the piston assembly is adjustable via a second gas inflation valve independent of the pressure of the gas in the main spring chamber.

18. The shock absorbing device of claim 14 further comprising:
a first seal engaged with the housing assembly, wherein the first seal moves with the piston assembly such that the first seal prevents at least one of:
the gas in the main spring chamber from exiting the main spring chamber; or
a gas in a negative spring chamber from entering the main spring chamber;
a second seal engaged with the housing assembly and the damper assembly, wherein the damper assembly moves relative to the second seal prevents at least one of:
the gas in the negative spring chamber from exiting the negative spring chamber; or
a gas external to the shock absorbing device to enter the negative spring chamber.

19. The shock absorbing device of claim 14, wherein the damper assembly is configured to engage the piston assembly to apply a force on the piston assembly to cause the piston assembly to move within the housing space and adjust the pressure of the gas in the main spring chamber.

20. The shock absorbing device of claim 14, wherein the elastic membrane selectively deforms when an amount of the force applied on the elastic membrane by the gas in the main spring chamber exceeds a threshold value.

21. The shock absorbing device of claim 14, wherein the main spring chamber comprises at least one of a spacer or a liquid to reduce the volume of the main spring chamber to cause the spring rate of the gas spring to be progressive.

22. The shock absorbing device of claim 14, wherein the secondary spring chamber comprises at least one of a spacer or a liquid to reduce the volume of the secondary spring chamber to cause the spring rate of the gas spring to be progressive.
